(19) United States
(12) Patent Application Publication
(10) Pub. No.: US 2006/0184467 A1
(43) Pub. Date: Aug. 17, 2006

(54) Sensor and sensor program storage medium

(75) Inventor: Fumio Nagashima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/269,542

(22) Filed: Nov. 9, 2005

Related U.S. Application Data
(63) Continuation of application No. PCT/JP03/06264, filed on May 20, 2003.

(51) Int. Cl. G06N 3/02

(52) U.S. Cl. 706/15

(57) ABSTRACT

A sensor, etc. detects that a dynamically input detected signal has been changed to a signal of a desired pattern, can be structured ina short time, and can be a low-cost sensor. A pattern generator has plural neurons including a neuron for generating output V₁ basically by an equation of

$${ɛ}_{1} \frac{ⅆ {V}_{1}}{ⅆ t} + {V}_{1} = {V}_{0}$$

where V₀ indicates an input, V₁ indicates an output, and ε₁ indicates a delay. The pattern generator is structured by a recurrent neural network including a loop of a stream of signals. When the pattern generator fetches a detected signal input from the signal input section, and the detected signal is changed to a signal of a desired pattern, an output different from an output obtained when the detected signal has a pattern other than a desired pattern is generated.

This application is a continuation application, filed under 35 USC 111(a), of International Application PCT/JP03/06264, filed May 20, 2003.

### TECHNICAL FIELD

The present invention relates to a sensor for detecting that a dynamically input detected signal has been changed to a signal of a desired pattern, and a sensor program storage mediumwhich stores a sensor program executed in an information processing device for executing a program and operating the information processing device as such a sensor.

### BACKGROUND ART

Conventionally, various processing styles have been used in processing a sensor. One type of the processing styles, a neural network is used in processing a sensor (for example, refer to Patent Documents 1 to 3). A neural network request referred to in this document is a artificial neural network generated by modeling a network of neurons of a person, etc., and can be classified into two major types, that is, a layered neural network where there is a distinction between upstream signals and downstream signals, but there is no loop of signal streams, and a recurrent neural network where there is a loop of signal streams.

FIG. 1 shows a model of a layered neural network (LNN).

In this model, neurons are arranged in each layer of an input layer, an intermediate layer, and an output layer. The input to the LNN is all received by the neurons of the input layer, the output of each neuron of the input layer is transmitted to each neuron of the intermediate layer, and the output of each neuron of the intermediate layer is transmitted to the neuron of the output layer, and the output of the neuron of the output layer is the output of the LNN.

FIG. 2 shows a model of each neuron configuring part of the LNN shown in FIG. 1. FIG. 3 shows a sigmoid function prescribing the relationship between the input and output neurons.

As shown in FIG. 2, when there are plural inputs X₁, X₂, X₃, . . . , Xᵢ, each coupling strength is set as W₁, W₂, W₃, . . . , Wᵢ, and the neurons receive the result of the following equation (1) as the entire input.

$$X = {\sum }_{i} {X}_{i} {W}_{i} \qquad ( 1 )$$

With the neuron, the output Y=f(X) following the sigmoid function shown in FIG. 43 and obtained by the following equation (2) is generated.

$$f ( X ) = \frac{1}{1 + exp ( - X )} \qquad ( 2 )$$

Relating to the LNN, it is necessary to determine the value of each coefficient called the coupling strength W₁, W₂, W₃, . . . , Wᵢ. There is a well-known BP method (back propagation method) as a method of determining the coefficient, and there are various learning methods such as a learning method with a teacher, a learning method without a teacher, etc.

The LNN is to basically apply a filter to input and output it, and a coefficient (the coupling strength W₁, W₂, W₃, . . . , Wᵢ above) of the filter can be set in the BP method.

Another well-known model of a neural network is a recurrent neural network (RNN).

FIG. 4 shows a model of an RNN.

In the LNN shown in FIG. 1, signals flow in order from the input side to the output side. However, in the RNN shown in FIG. 4, signals flow not only from the neurons at the input side to the neurons at the output side, but also from the output side to the input side, thereby generating a loop of a signal stream.

The RNN is actively studied, and there are some propositions of a method of learning an RNN such as the BP method in the LNN described above (refer to the Patent Documents 1 to 3).

A neural network used in processing a sensor such as the Patent Documents 1 to 3 is based on the nonlinear effect of the neural network, and has the disadvantage of requiring a long time in learning and is not practical. Although there is an attempt to shorten the time required in learning (refer to the Patent Document 4), it is impossible to remarkably shorten the learning time.
(Patent Document 1)
   Japanese Patent Laid-Open No. 4-156610
(Patent Document 2)
   Japanese Patent Laid-Open No. 8-123486
(Patent Document 3)
   Japanese Patent Laid-Open No. 9-160590
(Patent Document 4)
   Japanese Patent Laid-Open No. 9-244696

The present invention has been developed to solve the problems and aims at providing a low-cost sensor and a sensor program storage medium which stores a sensor program requiring only a low development cost.

### DISCLOSURE OF THE INVENTION

The sensor according to the present invention to attain the objectives is a sensor which detects a change of a dynamically input detected signal to a signal of a desired pattern. The sensor includes; a signal input section which inputs a detected signal: and a pattern generator having plural neurons containing at least one neuron for generating output accompanied by an analog delay based on the input signal, and having a configuration of a recurrent neural network including a loop of a signal stream. When the pattern generator fetches a detected signal input from the signal input section, and the detected signal is changed to a signal of a desired pattern, an output different from an output obtained when the detected signal has a pattern other than a desired pattern is generated.

The “analog delay” refers to a delay accompanied by a phenomenon of an output value changing with delay in response to a change of an input value.

The sensor according to the present invention is provided with a pattern generator using a recurrent neural network having a loop of signals explained with reference to FIG. 5. In the neuron configuring the recurrent neural network, a delay neuron which generates an output with an analog delay as defined above in response to an input is included, thereby generating a cyclical signal having an arbitrary waveform by realizing, for example, trigonometric functions having various cycles, generating a non-cyclical signals having various waveforms by realizing a polynomial, and detecting whether or not the dynamically input detected signal has changed to a cyclical signal or a non-cyclical signal matching the realized cyclical signal or non-cyclical signal.

The pattern generator according to the present invention is to be configured to generate an output other than an output obtained when a detected signal has a desired cyclical signal or generate when a matching non-cyclical signal is detected an output different from an output obtained when non-matching signal is detected. If a desired cyclical function or a non-cyclical function is known, learning corresponding to the “learning” in the conventional neural network is not required.

Otherwise, in the case of the sensor of the present invention, various cycles of trigonometric functions can be realized using the delay neurons or functions represented by various orders of polynomials can be realized. Therefore, although it is uncertain what degree of cyclical function or non-cyclical function is required, coefficients can be determined in order from lower order terms (from a longer-cycle trigonometric function in the case of a cyclical function, and from a lower-order term in the case of a polynomial). When a cyclical function or a non-cyclical function with necessary accuracy is realized, a higher order term can be ignored (not incorporated into a pattern generator). Thus, when “learning” the necessary accuracy of a desired cyclical function or non-cyclical function, the learning time can be shortened in the example explained later by the time represented by an enormously large value of 10⁵⁷ times shorter the time required in the “learning” in the conventional neural network in which all coefficients are simultaneously determined. As a result, a sensor which can be configured in a short time can be realized as a very low-cost sensor including the development cost.

In the sensor according to the present invention, it is desired that the pattern generator includes a neuron for generating output V₁ basically by the following equation (3)

$${ɛ}_{1} \frac{ⅆ {V}_{1}}{ⅆ t} + {V}_{1} = {V}_{0} \qquad ( 3 )$$

where V₀ indicates an input, V₁ indicates an output, and ε₁ indicates a delay.

In this example, the neuron is represented as shown in the equation (3), but it is desired that the following variation can be allowed. That is:

(a) An output accompanied by an analog delay is generated based on a total of plural inputs after receiving the plural inputs.

(b) A weight is applied to an input, and an output accompanied by an analog delay is generated based on the weighted input.

(c) When the neuron applies a weight to an input, the weight is changed depending on the output of another neuron.

(d) The delay of a neuron is changed depending on the output of another neuron.

(e) When an input exceeds a threshold, the threshold is used for the input.

The “analog delay” in the definition above which is represented by the simplest possible equation can be the equation (3) above. In representing the “analog delay” in the definition, it is not necessary to use an equation more complicated than the equation (3) above. Therefore, the definition of a neuron for generating an output accompanied by an “analog delay” can be made using the equation (3).

“When an input exceeds a threshold” indicate plural cases. That is, there can be a case where an input is effective when the input is smaller than a threshold, and when the input exceeds from a threshold of a small value to a large value, the threshold is effective, that is, the threshold is an upper limit. On the other hand, there can be a case where an input is effective when the input is larger than a threshold, and when the input exceeds from a threshold of a large value to a small value, the threshold is effective, that is, the threshold is a lower limit.

By allowing the variations, a wider cyclical function or non-cyclical function can be freely generated.

In the sensor of the present invention, the pattern generator may generate an output for discriminating whether or not a detected signal is a signal of a desired pattern by using an inner product of a signal generated in the pattern generator and a detected signal, or the pattern generator may generate an output for discriminating whether or not the detected signal is a signal of a desired pattern by using a coefficient drive.

Furthermore, in the sensor of the present invention, the pattern generator may generate a cyclical function in the pattern generator based on the nature of the detected signal (whether the signal of a desired pattern to be detected is a cyclical signal or a non-cyclical signal, etc.), or may generate a non-cyclical function represented by a polynomial in the pattern generator.

The sensor program storage medium according to the present invention to attain the objective of the invention stores a sensor program which is executed in an information processing device for executing a program, operates the information processing device as a sensor for detecting whether or not a dynamically input detected signal is a signal of a desired pattern, and operates the information processing device as a sensor including; a signal input section which inputs a detected signal: and a pattern generator having plural neurons containing at least one neuron for generating output accompanied by an analog delay based on the input signal, and having a configuration of a recurrent neural network including a loop of a signal stream. When the pattern generator fetches a detected signal input from the signal input section, and the detected signal is changed to a signal of a desired pattern, an output different from an output obtained when the detected signal has a pattern other than a desired pattern is generated.

In the sensor program storage medium according to the present invention, it is desired that the pattern generator includes a neuron for generating output V₁ basically by the following equation (3)

$${ɛ}_{1} \frac{ⅆ {V}_{1}}{ⅆ t} + {V}_{1} = {V}_{0} \qquad ( 3 )$$

where V₀ indicates an input, V₁ indicates an output, and ε₁ indicates a delay.

Also in the sensor program storage medium_according to the present invention, the pattern generator may use an inner product of the signal generated in the pattern generator and a detected signal, and the pattern generator may use a coefficient drive.

Additionally, in the sensor program storage medium according to the present invention, the pattern generator may generate a cyclical function in the pattern generator, or the pattern generator may generate a non-cyclical function represented by a polynomial in the pattern generator.

### BREIF DESCRIPTION OF DRAWINGS

FIG. 1 shows a model of a layered neural network (LNN)

FIG. 2 shows a model of each neuron forming part of the LNN shown in FIG. 1.

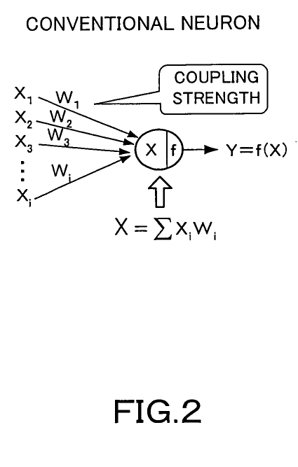

FIG. 3 shows a sigmoid function prescribing the relationship of the input/output of the neuron.

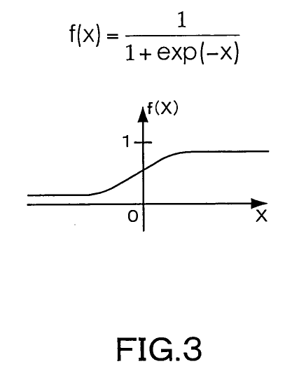

FIG. 4 shows a model of an RNN.

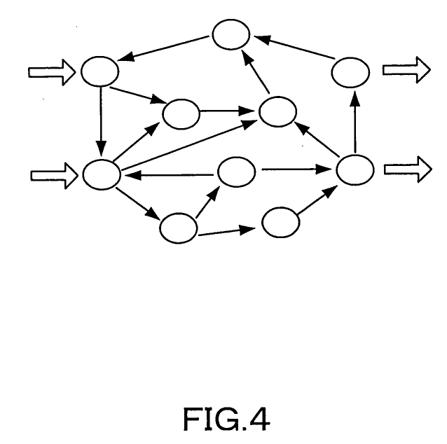

FIG. 5 shows a computer and the appearance of a robot communicating with the computer.

FIG. 6 is an explanatory view showing the principle of the ZMP method.

FIG. 7 shows the configuration of the hardware of the computer shown in FIG. 5.

FIG. 8 is a schematic diagram showing the outline of an embodiment of the sensor program stored in the sensor program storage medium according to the present invention.

FIG. 9 is a block diagram showing an embodiment of the sensor of the present invention.

FIG. 10 shows the description of a neuron.

FIG. 11 shows the description of the connection between neurons.

FIG. 12 shows a neuron without a time delay.

FIG. 13 shows a change in time of the input/output of a neuron without the time delay.

FIG. 14 shows a neuron having a delay ε₁ of ε₁≠0.

FIG. 15 shows a change in time of the input/output of a neuron having a time delay ε₁.

FIG. 16 shows a neurons of plural inputs.

FIG. 17 shows a neuron having an upper limit threshold.

FIG. 18 shows a neuron having a lower limit threshold.

FIG. 19 shows a common neuron including a weight explained by referring to FIG. 16, and a threshold explained by referring to FIGS. 17 and 18.

FIG. 20 shows a switch.

FIG. 21 shows a change in delay by a neuron.

FIG. 22 shows a change in weight of a coupling line by a neuron.

FIG. 23 shows an example of a combination of two neurons.

FIG. 24 shows an input/output of two neurons as a combination shown in FIG. 23.

FIG. 25 shows an example of a trigonometric function generator.

FIG. 26 shows a network obtained by combining plural trigonometric function generators shown in FIG. 25.

FIG. 27 shows another example of a trigonometric function generator.

FIG. 28 shows an n-th polynomial generator.

FIG. 29 shows a basic example of a pattern generator.

FIG. 30 shows another basic example of a pattern generator.

FIG. 31 shows a further basic example of a pattern generator.

### BEST MODE FOR CARRYING OUT THE INVENTION

An embodiment of the present invention is explained below.

A sensor according to an embodiment of the present invention explained below is configured by a computer and a sensor program operated in the computer as an embodiment of the present invention.

Described below first is the hardware of the computer configuring the sensor as an embodiment of the present invention.

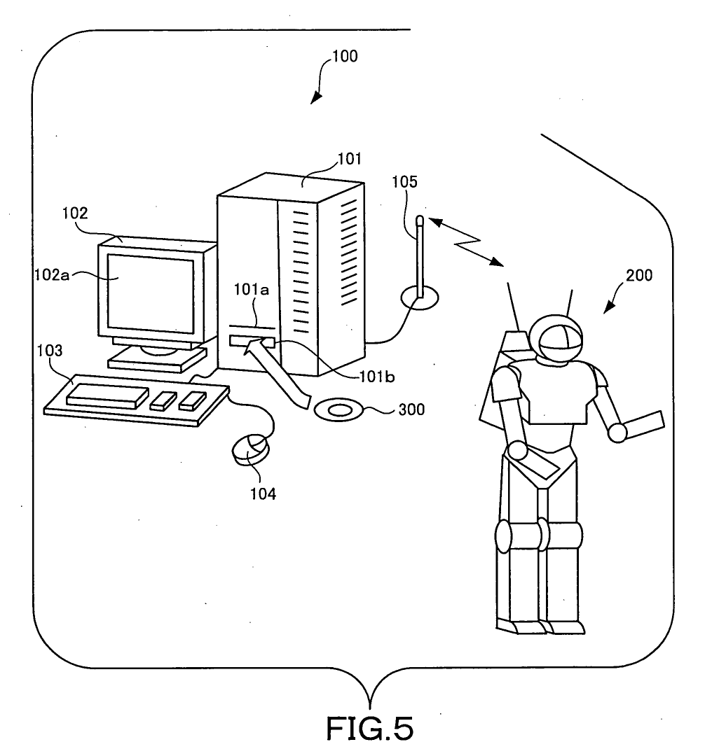

FIG. 5 shows a computer and the appearance of a robot communicating with the computer.

A computer is provided with a CPU (central processing unit), RAM (random access memory), a hard disk, a body section 101 having a built-in communication board, etc., a display device 102 for displaying an image and a character string on a display screen 102a at an instruction from the body section 101, a keyboard 103 for inputting an instruction of an operator to a computer 100, a mouse 104 for inputting an instruction depending on an icon, etc. displayed in a position when an arbitrary position on the display screen 102a is specified, and an antenna 105 for communication with a robot 200.

The body section 101 further includes an FD slot 101a for insertion of a flexible disk (not shown) and a CD-ROM slot 101b for insertion of CD-ROM 300. They also include an FD drive and a CD-ROM drive for driving and accessing the flexible disk (FD) and the CD-ROM 300 inserted respectively through the slots 101a and 101b.

On the other hand, the robot 200 takes the shape like a person, has joints at the positions corresponding to the joints of a person and formed by two adjacent members capable of making freely adjustable angles, and is provided with a camera at the positions of the eyes of a person, a microphone at the positions of the ears of a person, contact sensors at the positions corresponding to the tips of the fingers of a person, etc. Thus, various detecting sections are provided for the robot. The robot also has built-in communication equipment, communicates with the computer 100, transmits signals of various kinds to the computer 100, receives a control signal from the computer 100, and performs an operation such as bipedalism, etc. according to the control signal.

The computer 100 has a built-in robot structured in algorithm corresponding to the robot 200, and the control algorithm for control of the operation of the robot 200 structured using the computer 100 is not directly used in controlling the operation of the robot 200, but an operation simulation is performed by first operating using the control algorithm the robot as an algorithm structured in the computer 100. After confirming the intended operation, the control algorithm is applied to the robot 200 produced as hardware.

Relating to the control of the robot 200, for example, a conventionally used ZMP method (Zero Momentum Point method) can be adopted.

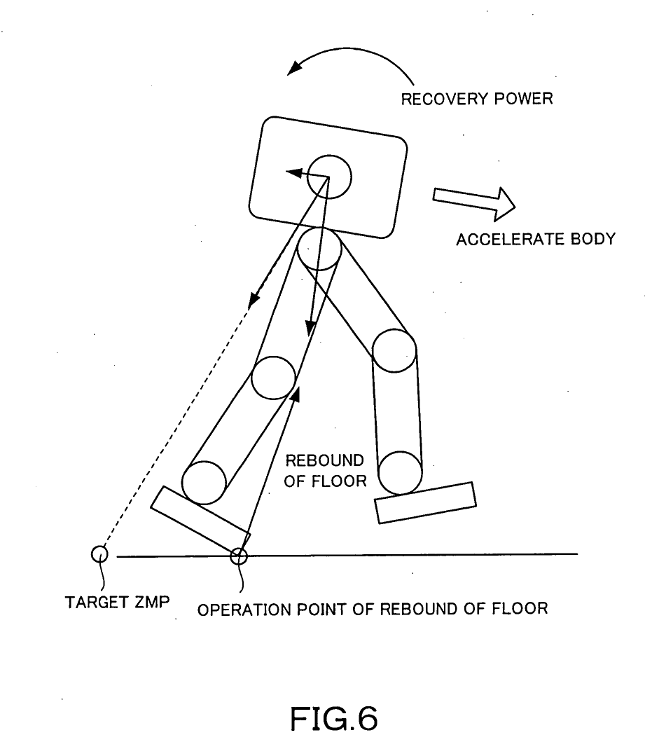

FIG. 6 is an explanatory view showing the principle of the ZMP method.

When the robot is standing still, the robot can keep the standing posture by raising the body upright with the barycenter of the robot kept right above its feet.

On the other hand, if the robot is, for example, moving forward, it will fall backward with the barycenter kept above its feet.

It is because the ZMP (dynamic barycenter point) is positioned backward. To prevent the robot from falling backward, the body is to lean forward and with an increasing speed to generate recovery power, and the leaning degree, etc. of the body can be adjusted such that the ZMP can be positioned at the target point with the rebound from the floor and the barycenter point of the robot taken into account. Thus, by controlling the ZPM (dynamic barycenter point) to be constantly located at the target position, the robot of bipedalism can move forward.

Otherwise, in controlling the robot 200, it is desired that the control system proposed by the Applicant of the present invention is used (refer to PCT/JP02/10622). This control system is to control the robot 200 according to signals generated as various cyclical signals and non-cyclical signals using a delayed neuron in the equation (3) above as a core, and it is an effective control system by sharing a number of common points with the sensor explained below.

The control algorithm of the robot 200 is not the subject of the present invention, but the subject as an embodiment of the present invention is to perform the process of detecting whether or not, after receiving a detected signal obtained by various detection sections provided for the robot 200 through communication equipment, the detected signal matches a signal of a desired pattern (this process is referred to as a sensor in the present invention). Therefore, the control systemof the robot is not referred to anymore, and the process of detecting a signal will be explained below.

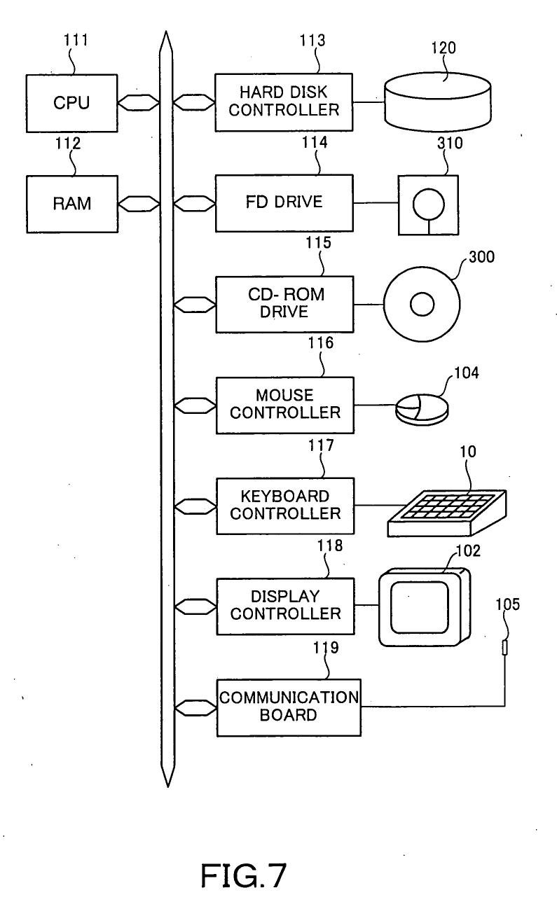

FIG. 7 shows the configuration of the hardware of the computer shown in FIG. 5.

This configuration of the hardware includes a CPU 111, RAM 112, a hard disk controller 113, an FD drive 114, a CD-ROM drive 115, a mouse controller 116, a keyboard controller 117, a display controller 118, and a communication board 119 for communication with the robot 200 (refer to FIG. 5), and these components are connected via a bus 110.

The FD drive 114 and the CD-ROM drive 115 are used in accessing an FD 310 and the CD-ROM 300 inserted respectively through the FD slot 101a and the CD-ROM slot 101b as explained by referring to FIG. 5. The communication board 119 communicates with the robot 200 through the antenna 105.

FIG. 7 also shows a hard disk 120, accessed by the hard disk controller 113, the mouse 104 for control by the mouse controller 116, the keyboard 103 for control by the keyboard controller 117, and the display device 102 for control by the display controller 118.

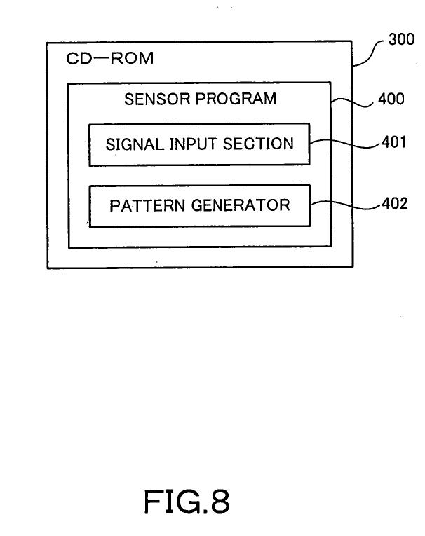

FIG. 8 is a schematic diagram showing the outline of an embodiment of the sensor program stored in the sensor program storage medium according to the present invention.

In FIG. 8, a sensor program 400 is stored in the CD-ROM 300, which is an embodiment of the sensor program storage medium according to the present invention. The CD-ROM 300 is inserted through the CD-ROM slot 101b shown in FIG. 5 and is accessed by the CD-ROM drive 115 shown in FIG. 7. The sensor program 400 stored on the CD-ROM 300 is installed on the computer 100 shown in FIGS. 5 and 7. When the sensor program installed on the computer 100 is executed in the computer 100, the computer 100 functions as an embodiment of the sensor of the present invention.

The sensor program 400 is stored in the CD-ROM 300 in this embodiment, but it is not necessary that it is stored in the CD-ROM. For example, it can be stored on other portable storage media such as an FD, etc. and installed on the computer 100, or can be installed on the computer 100 through a communication network (not shown in the attached drawings) from other devices, etc. It can also be stored in a hard disk (refer to FIG. 7), etc. of the computer 100 from the beginning so far as it can be finally executed by a computer.

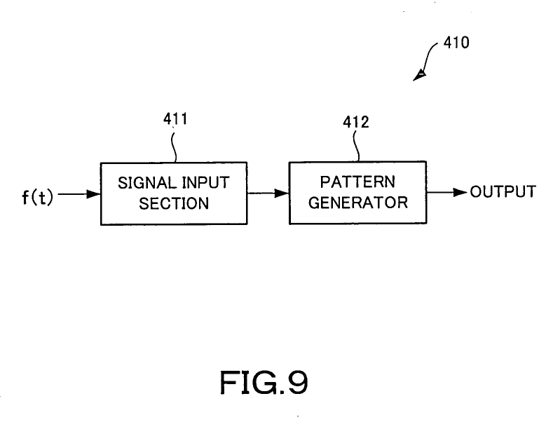

The sensor program 400 shown in FIG. 8 includes a signal input section 401 and a pattern generator 402. The operation of each of the sections 401 and 402 of the sensor program 400 will be explained with the explanation of FIG. 9.

FIG. 9 is a block diagram showing an embodiment of the sensor of the present invention.

A sensor 410 is realized in the computer 100 shown in FIGS. 5 and 7 by executing the sensor program 400 shown in FIG. 8 in the computer 100 shown in FIGS. 5 and 7.

The sensor 410 shown in FIG. 9 is configured by a signal input section 411 and a pattern generator 412. The signal input section 411 and the pattern generator 412 respectively correspond to the signal input section 401 and the pattern generator 402 of the sensor program 400 shown in FIG. 8. However, each of the sections 411 and 412 of the sensor 410 shown in FIG. 9 is configured by the hardware of the computer 100 shownin FIGS. 5 and 7, the operating system (OS) executed in the computer 100, and the coupling to each of the sections 401 and 402 of the sensor program 400 shown in FIG. 8 operated by the OS. In the meanwhile, each of the sections 401 and 402 of the sensor program 400 shown in FIG. 8 is configured only by a portion of composite application programs. The operation of each of the sections 401 and 402 configuring the sensor program 400 shown in FIG. 8 when the sensor program 400 is executed in the computer 100 shown in FIGS. 5 and 7 is the operation of each of the sections 411 and 412 configuring the sensor 410 shown in FIG. 9. The operation of each of the sections 411 and 412 of the sensor 410 shown in FIG. 9 will be described below, which also explains the operation of each of the sections 401 and 402 of the sensor program 400 shown in FIG. 8.

The sensor 410 shownin FIG. 9 detects that the dynamically input detected signal has changed to a signal of a desired pattern.

The signal input section 411 configuring the sensor 410 shown in FIG. 9 has the function of receiving a signal obtained by the detection section of the robot 200 through communication equipment, the antenna 105, the communication board 119, etc. shown in FIG. 7 perform the function.

The pattern generator 412 configuring the sensor 410 shown in FIG. 9 is structured by a recurrent neural network having plural neurons including at least one neuron for generating an output accompanied by an analog delay in response to an input, and including a loop of a stream of signals. The pattern generator 412 generates an output indicating the change of a signal input from the signal input section 411 to a signal of a desired pattern. As shown in FIG. 7, in terms of hardware, it is composed of the hard disk 120 storing the algorithm of the pattern generator 412, the hard disk controller 113 accessing the hard disk 120, the CPU 111 executing the algorithm, etc.

The neuron which generates an output of an analog delay contained in the pattern generator is defined as a neuron which generates an output V₁ by the following equation (3).

$${ɛ}_{1} \frac{ⅆ {V}_{1}}{ⅆ t} + {V}_{1} = {V}_{0} \qquad ( 3 )$$

where V₀ indicates an input, V₁ indicates an output, and ε₁ indicates a delay basically in the present embodiment.

The equation (3) can also be expressed by the equation (4) as follows by integrating the equation (3).

$${V}_{1} = C exp ( - \frac{1}{{ɛ}_{1}} t ) + {V}_{0} \qquad ( 4 )$$

The neuron is configured by program modules described to satisfy the equation (3) (or the equation (4) equivalent to the equation (3)).

The pattern generator 412 can include a neuron expressed by the equation (3) (or the equation (4) equivalent to the equation (3)), variations of the neuron, and others. The neurons, etc. that can be included in the pattern generator 412 in the present embodiment are listed as follows.

(a) A basic neuron according to the equation (3) (or equation (4))

(b) A neuron generating an output accompanied by an analog delay including a delay 0 based on the total of plural inputs in response to the plural inputs

(c) A neuron generating an output accompanied by an analog delay based on the weighted input after applying a weight to an input

(d) A neuron for which the weight is changed depending on the output of another neuron

(e) A neuron whose delay is changed depending on the output of another neuron

(f) A neuron using a threshold in place of an input when the input exceeds the threshold

(g) A switch communicating/disconnecting the coupling between two neurons depending on the output of another neuron

These neurons, etc. are formed by program modules as explained by referring to the equation (3) or (4). The pattern generator 412 shown in FIG. 9 is based on the RNN generated by combining the program modules according to the definitions in (a) to (g) above.

For the following explanation, a neuron and the description in the drawing of the neuron will be explained first.

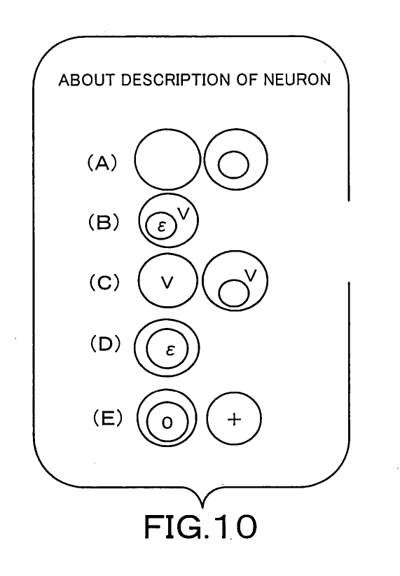

FIG. 10 shows the description of a neuron.

Parts (A) to (E) of FIG. 10 show neurons. A circle and double circles are assigned to Part (A) of FIG. 10. Theysimply indicate the existence of a neuron. A delay and an initial value can be defined for a neuron, but the description of Part (A) of FIG. 10 does not include the definitions.

Part (B) of FIG. 10 shows a neuron where V is described within the outer circle (outside the inner circle) of the double circles, and ε is described within the inner circle. In this case, the neuron has the delay of ε and the initial value of V.

Part (C) of FIG. 10 shows a neuron having V in the circle, and a neuron expressed by double circles having V inside the outer circle and outside the inner circle. These descriptions indicate neurons of having the initial value of V, and no delay is defined.

Part (D) of FIG. 10 shows a neuron having ε within the inner circle of the double circles. The neuron has a delay of ε, but no initial value is defined.

Part (E) of FIG. 10 shows a neuron without delay as a special case of Part (D) of FIG. 10. A neuron without delay is to obtain a total of plural inputs when there are plural inputs. Therefore, there is a case where a symbol having “+” indicating addition is described in the circle in place of the symbol having the number 0 within the inner circle of the double circles.

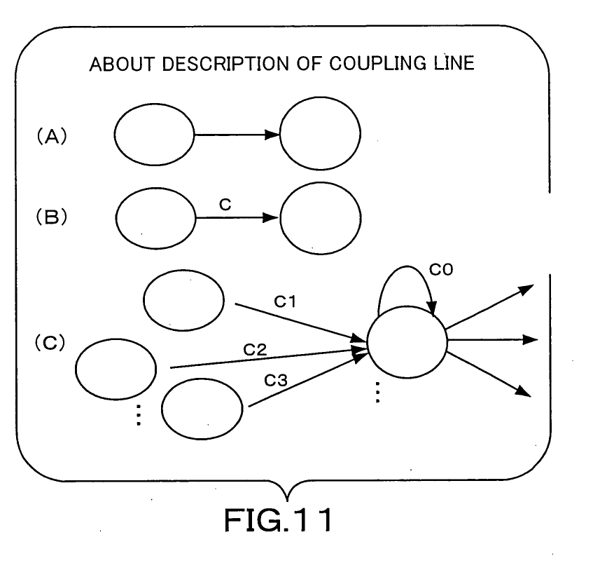

FIG. 11 shows the description of the connection between neurons.

Part (A) of FIG. 11 shows that a signal flows from the neuron on the left to the neuron on the right, and the output of the left neuron is the input of the right neuron.

Part (B) of FIG. 11 is the same as the neuron of Part (A) of FIG. 11 in that the output of the left neuron is the input of the right neuron. However, relating to the right neuron of Part (B) of FIG. 11, the weight C is applied to the input, and arithmetic operations are performed by the equations (3) and (4) based on the weighted input.

Part (C) of FIG. 11 shows that the plural outputs of the plural left neurons are input to the right neurons and weighted by the weights C1, C2, C3, . . . , and the outputs of them are input again and weighted by the weight C0. On the right neuron, the arithmetic operation by the equation (3) (or the equation (4)) is performed based on the total of plural weighted inputs.

Then, using the descriptions shown in FIGS. 10 and 11, the definition of a neuron and the behavior (relationship between input and output, realized function, etc.) of the neuron will be explained below.

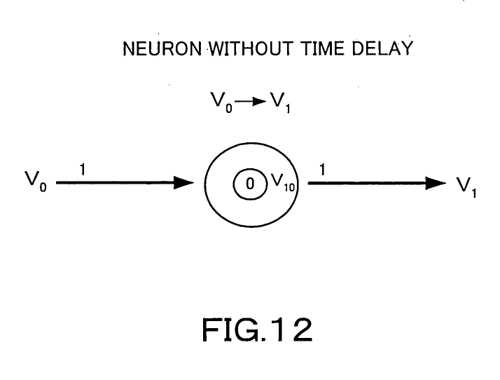

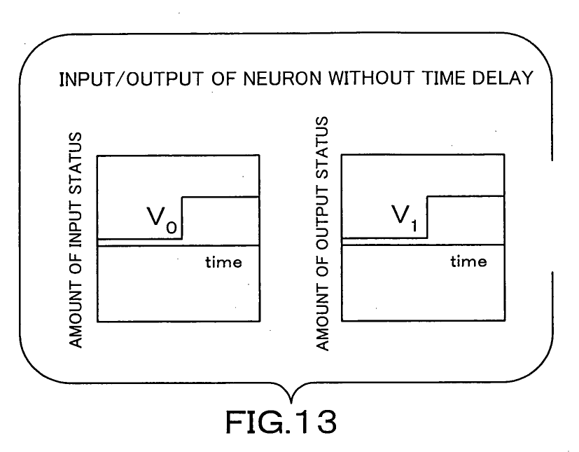

FIG. 12 shows a neuron without time delay. FIG. 13 shows a change in time of the input/output of a neuron without the time delay.

The equation (3) is displayed again below.

$${ɛ}_{1} \frac{ⅆ {V}_{1}}{ⅆ t} + {V}_{1} = {V}_{0} \qquad ( 3 )$$

When a delay ε₁ is set to zero, the equation (3) is expressed as follows.
V₁=V₀ (5)

That is, when a delay ε₁=0, the output V₁ is the input V₀ as shown in FIG. 13.

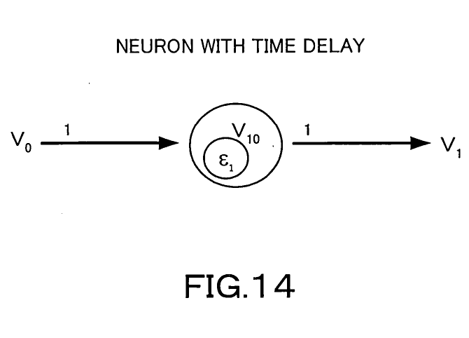

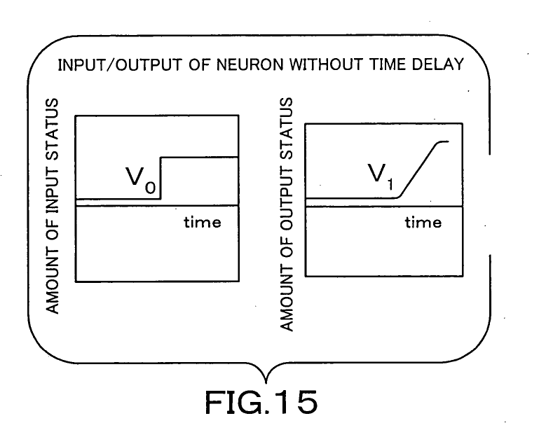

FIG. 14 shows a neuron having a delay ε₁ of ε₁≠0. FIG. 15 shows a change in time of the input/output of a neuron having a time delay ε₁.

In this case, the delay ε₁ in the equation (3) above is processed with ε₁≠0. The equation (3) is integrated and expressed as the equation (4) above. The equation (4) is shown again below.

$${V}_{1} = C exp ( - \frac{1}{{ɛ}_{1}} t ) + {V}_{0} \qquad ( 4 )$$

where the integration constant C in the equation (4) depends on the initial value of V₁₀, and the following equation holds.
C=V₀−V₁₀ (6)

The first term of the equation (4) above shows that the output V₁, is delayed in time, and is gradually changed as shown in FIG. 15.

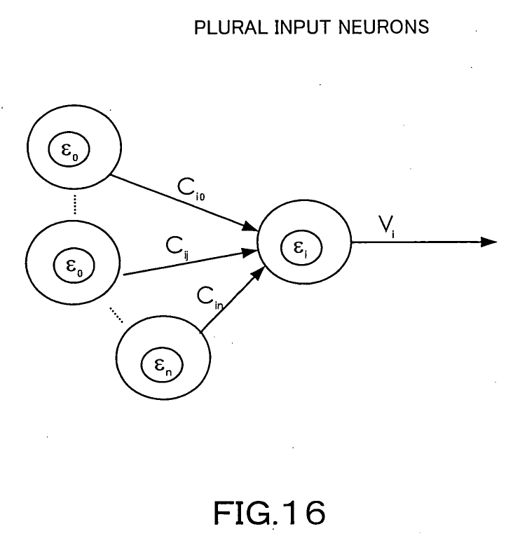

FIG. 16 shows plural input neurons.

In this case, plural input Vⱼ(j=0, 1, . . . , n) is weighted by each weight Cᵢⱼ (j=0, 1, . . . , n) corresponding to each input, and a total of weighted inputs is processed as corresponding to the input V₀ of the equation (3). That is, when an equation is prepared using the symbols shown in FIG. 16, the following equation holds.

$${ɛ}_{i} \frac{ⅆ {V}_{i}}{ⅆ t} + {V}_{i} = {\sum }_{j = 0}^{n} {C}_{ij} {V}_{j} \qquad ( 7 )$$

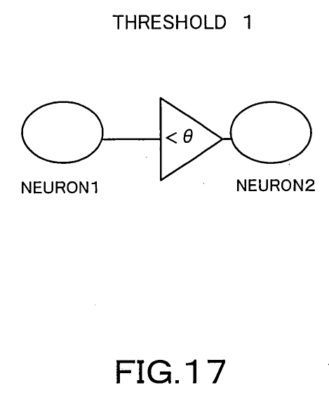

FIG. 17 shows a neuron having an upper limit threshold.

In this example, when the output of the neuron 1 is smaller than the threshold θ, the output of the neuron 1 is input as is to the neuron 2. When the input of the neuron 1 is equal to or larger than the threshold θ, the output of the neuron 1 is replaced with the threshold θ and processed as an input in the neuron 2.

In the neuron 2, an arithmetic operation according to the equation (3) (or (4) is performed after the threshold θ is processed as an input depending on the value of the output of the neuron 1.

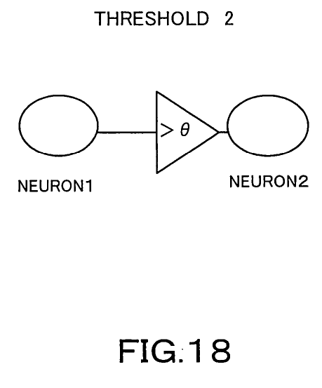

FIG. 18 sows a neuron having a lower limit threshold

In this example, when the output of the neuron 1 is larger than the threshold θ, the output of the neuron 1 is input as is to the neuron 2. When the output of the neuron 1 is equal to or smaller than the threshold θ, the neuron 2 processes the threshold θ as an input.

In this example again, as in the case shown in FIG. 17, the neuron 2 is the same as the basic neuron except that the threshold is processed as an input depending on the output value of the neuron 1, and an arithmetic operation is performed by the equation (3) (or (4)).

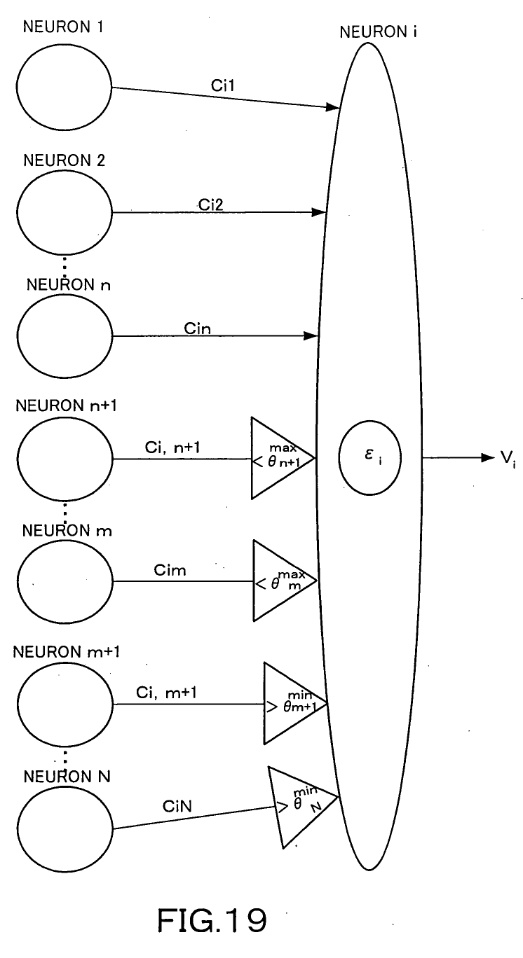

FIG. 19 shows a common neuron including a weight explained by referring to FIG. 16, and a threshold explained by referring to FIGS. 17 and 18.

The equation describing the relationship of the input and the output of the neuron j shown in FIG. 19 is expressed below.

$$\begin{matrix}{ɛ}_{i} \frac{ⅆ {V}_{i}}{ⅆ t} + {V}_{i} = {\sum }_{j = 1}^{n} {C}_{ij} {V}_{j} + {\sum }_{j = n + 1}^{m} {C}_{ij} \cdot min ( {θ}_{j}^{max} , {V}_{j} ) + \\ {\sum }_{j = m + 1}^{N} {C}_{ij} \cdot max ( {θ}_{j}^{min} , {V}_{j} )\end{matrix} \qquad ( 8 )$$

where Vⱼ (j=1, 2, . . . , n, . . . m, . . . N) is an output of the neuron j, Cᵢⱼ is a weight corresponding to the coupling line from the neuron j to the neuron i, θ^{max}ⱼ is a threshold for determination of the maximum value and corresponding to the coupling line from the neuron j to the neuron i, θ^{min}ⱼ is a threshold for determination of the minimum value and corresponding to the coupling line from the neuron j to the neuron i, min (x, y) is a function using the value of x or y whichever is smaller, and max (x, y) is a function using the value of x or y whichever is larger.

The neuron i can be one of the neurons 1 to N (in this case, as shown by Part (C) of FIG. 11, the output of the neuron i can be described to be returned to the same neuron i), or the neuron i can be different from any of the neurons 1 to N.

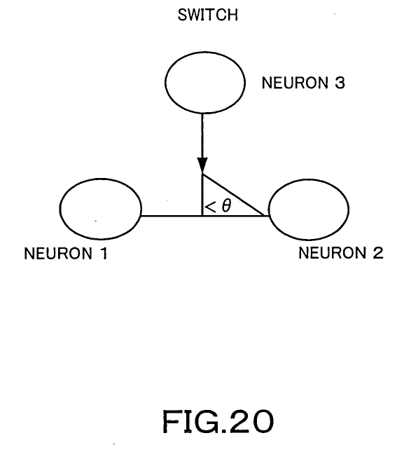

FIG. 20 shows a switch.

The neurons 1 and 2 are coupled through a switch. The switch can be connected/disconnected depending on the output of another neuron 3. In this example, when the output of the neuron 3 is smaller than the threshold θ, the switch is connected to make the output of the neuron 1 as the input of the neuron 2. When the output of the neuron 3 is equal to or larger than the threshold θ, the switch is disconnected to prevent the output of the neuron 1 from entering the neuron 2. FIG. 20 shows the symbol “<θ”. When it is changed to “≦θ”, and if the output of the neuron 3 is equal to the threshold θ, it indicates that the switch is connected.

When the symbol “<θ” shown in FIG. 20 is changed to “>θ”, the switch is connected if the output of the neuron 3 exceeds the threshold θ, and the switch is disconnected and the output of the neuron 1 is not transmitted to the neuron 2 if the output of the 3 is equal to or smaller than the threshold θ. If the symbol “>θ” is changed to the symbol “≧θ”, the switch is connected when the output of the neuron 3 is equal to the threshold.

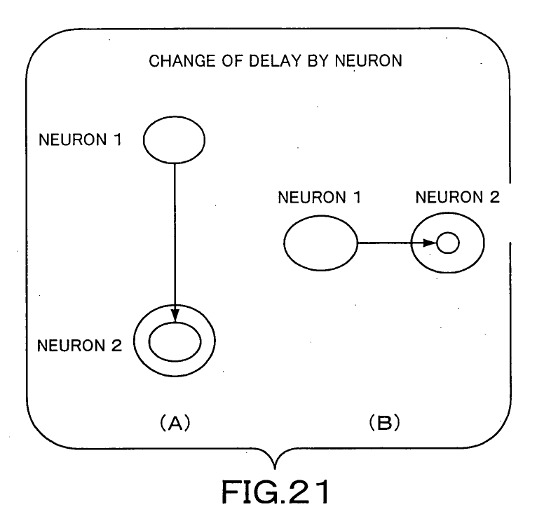

FIG. 21 shows a change in delay by a neuron.

Part (A) of FIG. 21 and Part (B) of FIG. 21 are drawn in the different directions only, and have the same meanings. In this example, an arrow is drawn from the neuron 1 to the inner circle of the double circles indicating the neuron 2. In this case, it means that the output of the neuron 1 is the delay ε₁ of the neuron 2 (the neuron 1 sets and changes the delay of the neuron 2). Thus, in this case, the neurons are defined such that the delay of a neuron (the neuron 2 in the example shown in FIG. 21) can be changed by the output of another neuron (neuron 1 in the example shown in FIG. 21).

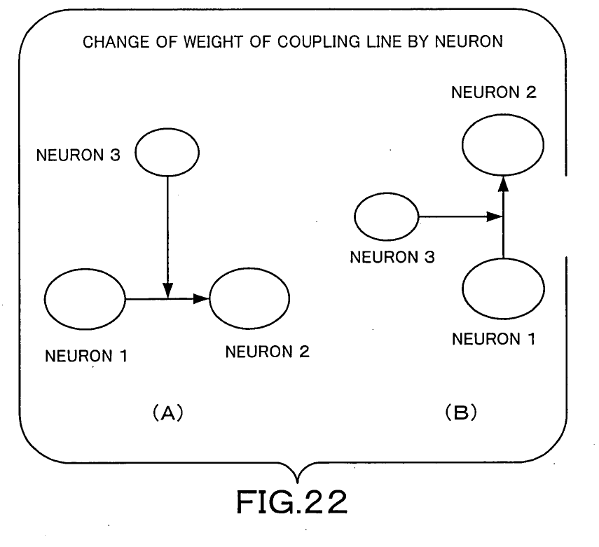

FIG. 22 shows a change in weight of a coupling line by a neuron.

As in the case shown in FIG. 21, Parts (A) and (B) of FIG. 22 are only drawn in the different directions, but have the same meanings. In this example, the output of the neuron 1 is input to the neuron 2, and a weight is applied to the input, but the output of the neuron 3 is a weight. Thus, in the example, the neurons are defined such that, by setting the output of a neuron (the neuron 3 in this example) as a weight, the weight can be changed.

The pattern generator 412 configuring the sensor 410 shown in FIG. 9 is basically structured by a set of program modules describing the relationship between the input/output of various neurons, etc. explained above. To more easily structure the pattern generator, in addition to the program modules describing the explained neurons, etc., a combination of plural frequently used neurons described below can be defined as a program module so that a program module as a combination of plural neurons can be used when a pattern generator is structured.

Described below is the function generated when plural neurons are combined.

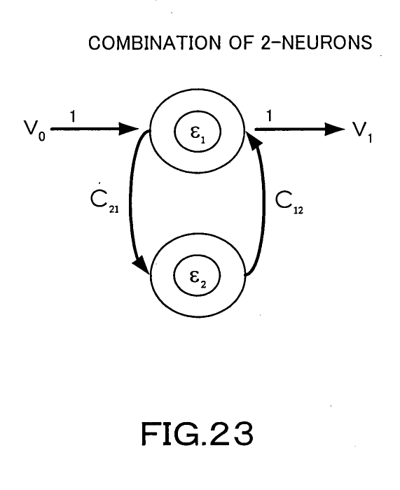

FIG. 23 shows an example of a combination of two neurons.

When two neurons are combined as shown in FIG. 23, the following equation (9) holds for the upper neuron.

$${ɛ}_{1} \frac{ⅆ {V}_{1}}{ⅆ t} + {V}_{1} = {C}_{12} {V}_{2} = {V}_{0} \qquad ( 9 )$$

The following equation (10) holds for the lower neuron.

$${ɛ}_{2} \frac{ⅆ {V}_{2}}{ⅆ t} + {V}_{2} = {C}_{21} {V}_{1} \qquad ( 10 )$$

where V₂ indicates the output of the lower neuron.

When the equations (9) and (10) are combined, the two-story linear constant coefficient differential equation is generated as follows.

$${ɛ}_{1} {ɛ}_{2} \frac{{ⅆ}^{2} {V}_{1}}{ⅆ {t}^{2}} + ( {ɛ}_{1} + {ɛ}_{2} ) \frac{ⅆ {V}_{1}}{ⅆ t} + ( 1 - {C}_{12} {C}_{21} ) {V}_{1} = {V}_{0} \qquad ( 11 )$$

A common solution to the two-story linear constant coefficient differential equation is expressed as follows.

$${ɛ}_{1} {ɛ}_{2} \frac{{ⅆ}^{2} {V}_{1}}{ⅆ {t}^{2}} + ( {ɛ}_{1} + {ɛ}_{2} ) \frac{ⅆ {V}_{1}}{ⅆ t} + ( 1 - {C}_{12} {C}_{21} ) {V}_{1} = {V}_{0} \\ {ɛ}_{1} {ɛ}_{2} {D}^{2} + ( {ɛ}_{1} + {ɛ}_{2} ) D + ( 1 - {C}_{12} {C}_{21} ) {V}_{1} = 0 \\ {D}_{1} = \frac{- ( {ɛ}_{1} + {ɛ}_{2} ) + \sqrt{{( {ɛ}_{1} + {ɛ}_{2} )}^{2} - 4 {ɛ}_{1} {ɛ}_{2} ( 1 - {C}_{12} {C}_{21} )}}{2 {ɛ}_{1} {ɛ}_{2}} \\ {D}_{2} = \frac{- ( {ɛ}_{1} + {ɛ}_{2} ) + \sqrt{{( {ɛ}_{1} + {ɛ}_{2} )}^{2} - 4 {ɛ}_{1} {ɛ}_{2} ( 1 - {C}_{12} {C}_{21} )}}{2 {ɛ}_{1} {ɛ}_{2}} \\ {V}_{1} = {C}_{1} exp ( {D}_{1} t ) + {C}_{2} exp ( {D}_{2} t ) \qquad ( 12 )$$

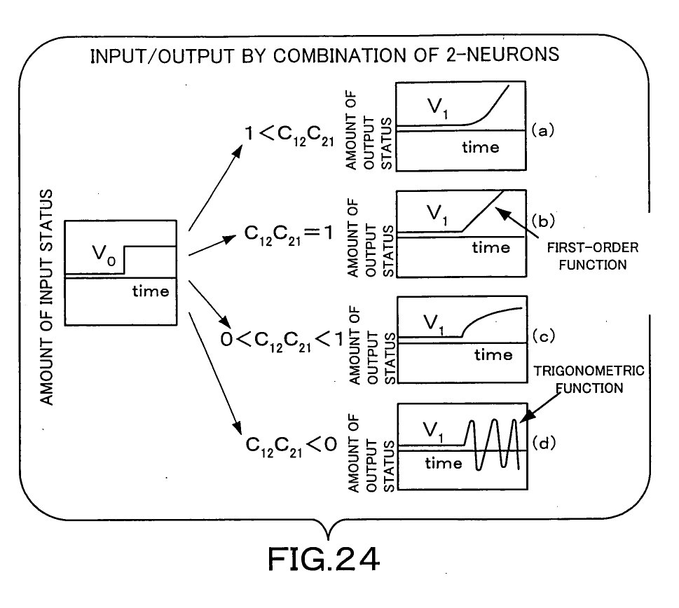

FIG. 24 shows an input/output of two neurons as a combination shown in FIG. 23.

When the input V₀ rises as a step function, the output V₁ changes as shown by Parts (a), (b), (c), and (d) of FIG. 24 depending on 1<C₁₂C₂₁, C₁₂C₂₁=1, 0<C₁₂C₂₁<1, C₁₂C₂₁<0. The noticeable point is that the output V₁ fluctuates depending on the values of the weights C₁₂ and C₂₁ although the input V₀ is a constant, and that there is an output obtained by superposing integration on a delay (refer to Part (b) of FIG. 24).

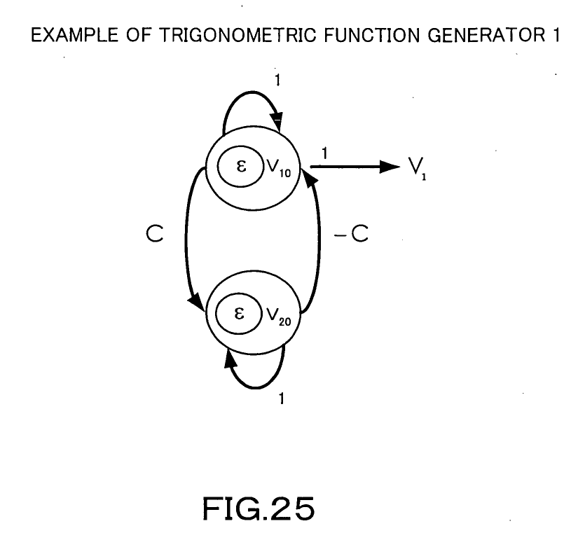

FIG. 25 shows an example of a trigonometric function generator.

FIG. 25 shows two coupled neurons as in coupling the two neurons shown in FIG. 23. The difference from the two coupled neurons shown in FIG. 23 is that there is no input V₀, and that the weights C₂₁ and C₁₂ have the same absolute value and different signs as C and −C.

The output V₁ shown in FIG. 25 is expressed as follows.

$$\frac{{ⅆ}^{2} {V}_{1}}{ⅆ {t}^{2}} + {ω}^{2} {V}_{1} = 0 \\ ω = \frac{C}{ɛ} \qquad ( 13 )$$

When the equation (13) above is integrated, the following equation (14) is obtained.

$${V}_{1} = {c}_{1} cos ω t + {s}_{1} sin ω t \\ {c}_{1} = {V}_{10} \\ {s}_{1} = - \frac{ɛ {V}_{20}}{C} \qquad ( 14 )$$

That is, the equation (13) or (14) expresses a trigonometric function of an angular frequency ω, and the output V₁ changing in the form of a sine wave.

Based on the equations (13) and (14), it is understood that when the values of the weight C and the delay ε are changed, the angular frequency of the sine wave output V₁ can be changed, and when the weight C, delay ε, and the initial values V₁₀ and V₂₀ are changed, the coefficients C₁ and S₁ in the equation (14) are changed, thereby possibly changing the phase and the amplitude of the sine wave.

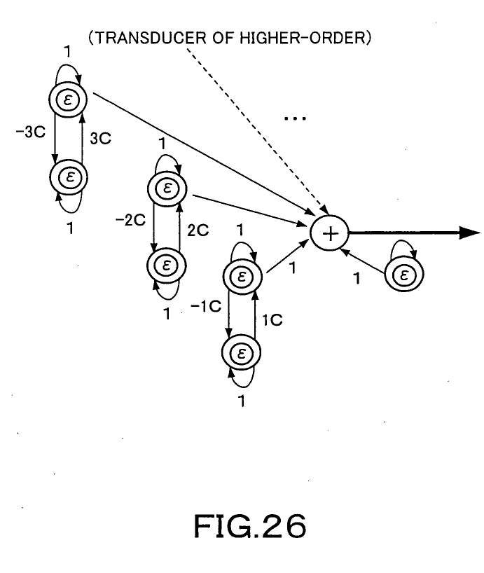

FIG. 26 shows a network obtained by combining plural trigonometric function generators shown in FIG. 25.

One rightmost neuron shown in FIG. 26 has the function of continuously outputting its initial value (in this example, c₀ corresponding to the equation (15) below).

The function realized by the network shown in FIG. 26 is expressed below.
V₁=c₀+c₁ cos ωt+s₁ sin ωt
+c₂ cos 2ωt+s₂ sin 2ωt
+c₃ cos 3ωt+s₃ sin 3ωt
+ (15)

The constant term c₀ and c₁, s₁, c₂, s₂, . . . , etc. are determined depending on the delay ε of each neuron, the weights C, 2C, 3C, . . . , the initial value (not shown in FIG. 26) as explained by referring to FIG. 26 (refer to the equations (13) and (14).

The equation (15) indicates the Fourier series. An arbitrary cyclical function can be developed to the Fourier series, and therefore any sigmoid function can be structured as shown in FIG. 26 by combining plural two-neurons as combined as shown in FIG. 25.

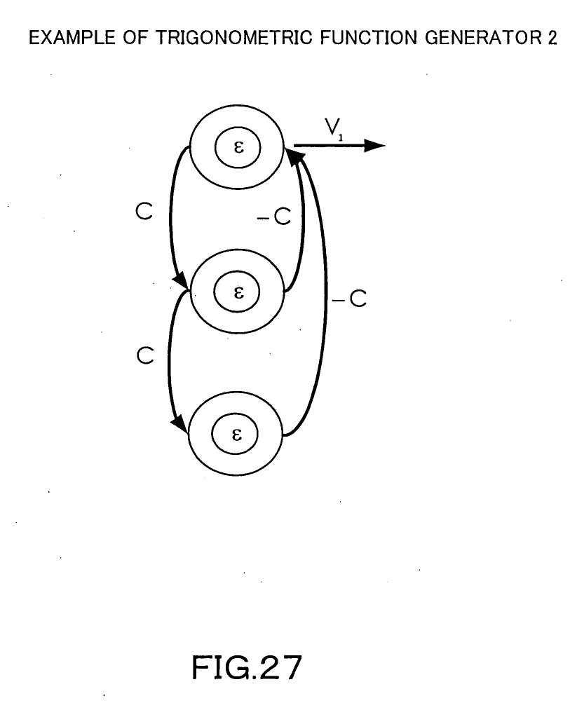

FIG. 27 shows another example of a trigonometric function generator.

The output V₁ generated by combining 3-neurons as shown in FIG. 27 is expressed by the following equation.

$$\begin{matrix}\begin{matrix}{ɛ}^{3} \frac{{ⅆ}^{3} {V}_{1}}{ⅆ {t}^{3}} + 3 {ɛ}^{2} \frac{{ⅆ}^{2} {V}_{1}}{ⅆ {t}^{2}} + ω ( 3 - {C}^{2} ) \\ \frac{ⅆ {V}_{1}}{ⅆ t} + ( 1 - {C}^{2} - {C}^{3} ) {V}_{1}\end{matrix} = 0 & ( 16 ) \\ C = \frac{12 \sqrt[3]{- 108 + 12 \sqrt{93}}}{12 - {( - 108 + 12 \sqrt{93} )}^{2 / 3}} & ( 17 )\end{matrix}$$

When the equation (17) holds, the equation (16) can be solved as follows.

$${V}_{1} {C}_{1} {ⅇ}^{- 2 t} + {C}_{2} cos ( ω t ) + {C}_{3} sin ( ω t ) \\ ω = \frac{\frac{\sqrt{3}}{2} ca + \frac{2 c}{a}}{ɛ} \\ c = \frac{12 a}{12 - {a}^{2}} \qquad ( 18 )$$

where C₁, C₂, and C₃ are integral constants determined by the initial value (not shown in the attached drawings), etc.

When looking at the equation about V₁ in the equation (18) above, the first term indicates quick attenuation, and the second and third terms indicate sine transients.

Therefore, the combination of the neurons shown in FIG. 27 can be used in detecting that the joint standing still in a position or posture moves to a position or posture (angle) different from the static position or static posture, and makes a sine transient based on the position or posture after the movement.

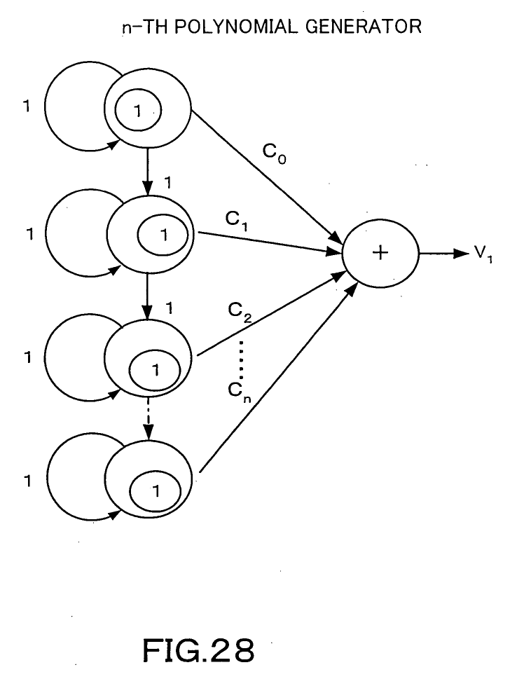

FIG. 28 shows an n-th polynomial generator.

FIG. 28 shows a total of n+2 neurons by connecting n+1 neurons for generating each term of the n-th order polynomial and the addition neuron (neurons without delay, refer to Part (E) of FIG. 10) for weight addition of the output as connected as shown in FIG. 28.

The output V₁ of the addition neuron is expressed below.
V₁=C₀+C₁t+C₂t²+ . . . +Cₙtⁿ (19)

When plural trigonometric function generators are combined as shown in FIG. 26, an arbitrary cyclical signal can be generated. Using the polynomial shown in FIG. 28, a non-cyclical signal can be generated.

The switch described above is used in switching the two types of generated signals. It is a pattern generator shown in FIG. 9. A signal pattern A is generated up to certain timing, and afterwards the signal pattern A is replaced with a signal pattern B.

As described above, almost all cyclical signals and non-cyclical signals can be practically generated by defining a neuron. Described below is detection of a signal based on the description above, that is, the pattern generator 412 shown in FIG. 9 is described below. Since it has been explained above that almost all patterns of signals can be generated by defining a neuron as described above, it is sufficient to show a basic algorithm for detection of a signal. To avoid complicated explanation, only basic examples are explained here.

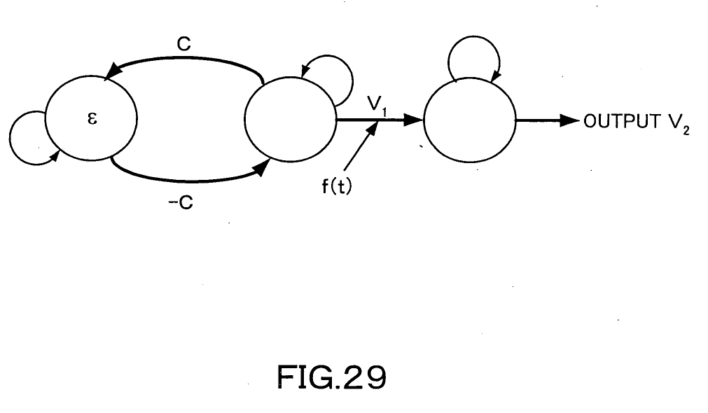

FIG. 29 shows a basic example of the pattern generator 412 shown in FIG. 9.

A signal f (t) is received from the signal input section 411 shown in FIG. 9.

In the three neurons shown in FIG. 29, the two left and center neurons generate a sine wave signal V₁ (FIG. 25, refer to the equation (14)).

One right neuron shown in FIG. 29 is an integrator. To the neuron, the sine wave signal V₁ is weighted by the signal f (t) received from the signal input section 411 shown in FIG. 9, that is, the V₁·f (t), is input. As a result, the following equation (19) is generated.
V₂=∫₀^{T}V₁·f(t)dt (19)

where T indicates a sufficiently long time as compared with the cycle determined by the angular frequency ω.

The equation (19) shows an inner product of the sine wave signal V₁ and the signal f (t) received from the signal input section 411 shown in FIG. 9.

When f (t) is the same sine wave signal, the output signal V₂ expressed by the equation (19) indicates a large value. When f (t) is a cyclical signal having a frequency different from the frequency of V₁ or when it is a non-cyclical signal, the output signal V₂ indicates a small value.

Therefore, according to the pattern generator having the configuration shown in FIG. 29, it can be detected whether or not the same signal component as V₁ is contained in the signal f (t).

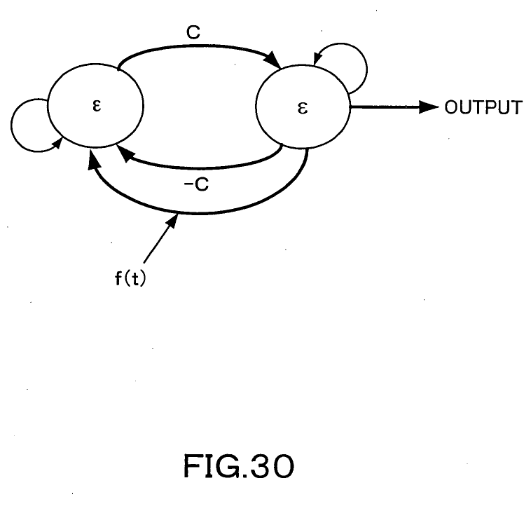

FIG. 30 shows another basic example of the pattern generator 412 shown in FIG. 9.

The signal f (t) is received from the signal input section 411 shown in FIG. 9 as in the case shown in FIG. 29.

The output V₁ shown in FIG. 30 can be expressed below.

$$\frac{{ⅆ}^{2} {V}_{1}}{ⅆ {t}^{2}} + {ω}^{2} ( 1 + f ( t ) ) {V}_{1} = 0 \qquad ( 20 )$$

The equation (20) includes the term of ω²(1+f(t)), and this corresponds to a change of a spring constant. That is, it is an equation showing the coefficient drive, and when f (t) is a sine wave having an angular frequency (half cycle) twice as high as the basic sine wave (sine wave of the angular frequency ω) generated by the pattern generator, a large output V₁ is generated.

Using the pattern generator with the configuration shown in FIG. 30, it is detected whether or not a signal clearly contains the element of a desired frequency (frequency twice as high as the frequency of the basic sine wave generated by the pattern generator).

The sine wave of a single frequency has been explained, and an arbitrary cyclical function can be generated by combining the patterns of generating a sine wave of a different frequency as described above. Therefore, a pattern generator having a large output when the signal f (t) is an arbitrary cyclical signal can be structured.

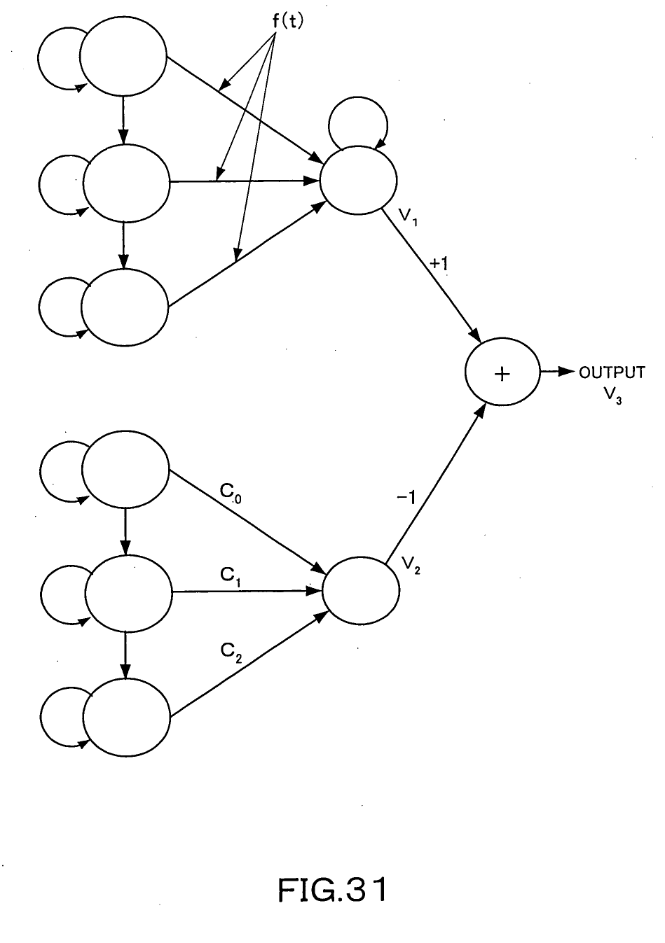

FIG. 31 shows a further basic example of the pattern generator 412 shown in FIG. 9.

In this example, a signal received from the signal input section 411 shown in FIG. 9 is f (t).

FIG. 31 shows two partial patterns for generating polynomials. In the upper partial pattern, the following equation is generated.
V₁=∫₀^{T}f(t)dt +∫₀^{T}t·f(t)dt +∫₀^{T}t²·f(t)dt (21)

In the lower partial pattern, the following equation is generated.
V₂=C₀+tC₁+t²C₂ (22)

Therefore, the output V₃ is expressed as follows.
V₃=[∫₀^{T}f(t)dt−C₀]+[∫^{T}₀t·f(t)dt−tC₁]+[∫₀^{T}t²·f(t)dt−t²C₃] (23)

That is, in the pattern generator shown in FIG. 31, when a signal f (t) with the following components is input, the output V₃ is close to zero.

integral value of f(t): C₀

integral value of t·f(t): t·C₁

integral value of t²·f(t): t²·C₂

When the output V₃ is close to zero, it indicates that a signal of a desired pattern has been detected.

In this example, a polynomial having only three terms is shown, but it can be a higher-order polynomial. When it is uncertain what order of polynomial is enough for detection with required accuracy, the lowest-order term is moved, while inputting a signal to be detected as a signal f (t), the output V₃ is evaluated to determine the coefficient C₀, then the coefficients C₀, C₁, C₂, etc. are determined while sequentially adding higher-order terms until a desired evaluation can be obtained. Thus, sequentially more accurate detection can be performed, the order required for a polynomial can be determined, and the values of the coefficients C₀, C₁, C₂, etc. can be determined.

When the process of determining these coefficients C₀, C₁, C₂, etc. is regarded as the “learning” in the conventional neural network and called “learning”, there can be a case where the “learning” is required in structuring the pattern generator 412 also in the present invention. However, the “learning” in the present invention refers to determining a coefficient one by one while sequentially adding each term from a lower order term to a higher order term. On the other hand, the “learning” in the conventional neural network simultaneously and little by little adjusts a number of coefficients, which is a definite different from the present invention. In this example, a polynomial is shown, but the same holds true with a cyclical function. In the present invention, a method of sequentially determining a coefficient while sequentially adding a term from a lower frequency term to a higher frequency term can be adopted.

Explained below is the comparison between the method of sequentially obtaining the coefficient of a pattern generator described above from a lower order to a higher order (hereinafter referred to as a method according to the present invention) and the method of simultaneously obtaining coefficients of the pattern generator using what is called a genetic algorithm (hereinafter referred to as a conventional method). A genetic algorithm refers to a technique of changing and evaluating the value of a coefficient using a model of heredity of creatures to finally determine an appropriate value by evaluating the value by assigning a slightly different value to a coefficient, by evaluating the value by assigning a completely different value to a coefficient to simulate a break, by evaluating the value by assigning an intermediate value between two values obtained with good evaluation to simulate heredity to a child, etc.

In the conventional method, all coefficients can be simultaneously obtained. Therefore, all coefficients are related to one another. It is anticipated that, when a movement is to be changed only a little, all coefficients have the influence, and take a long time to complete the change. The most apparent difference is briefly described below by referring to the case where all solutions are searched for. When the resolution of a neuron and the resolution of a coupling weight are set to n, and a total of the final number of neurons and the number of couplings between neurons is set to m, the amount of calculation when a total search is performed requires n^{m} times of performance. If a division to j orders is made in the present invention, the amount of calculation is approximately jxn^{m/j}. Practically, the values n^{m}=1.15×10⁷³, jxn^{m/j}=1.4×10¹⁶ are about 10⁵⁷ times as large as the values n=16, m=60, and j=5 respectively.

Thus, according to the present invention, coefficients can be determined in a much shorter time by exceedingly large number than the conventional method.

Therefore, the pattern generator generated by adopting the method according to the present invention can considerably reduce the development period and cost.

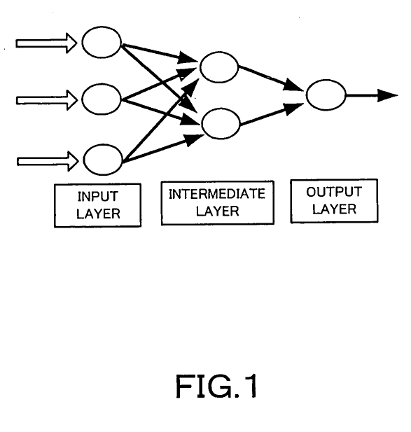

As shown in FIG. 1, the sensor structured in the general-purpose computer 100 as described above can also be a dedicated sensor having a pattern generator with the definite configuration for a determined target to be detected and incorporated into the robot as shown in FIG. 5.

1. A sensor which detects a change of a dynamically input detected signal to a signal of a desired pattern, comprising:
a signal input section which inputs a detected signal; and
a pattern generator which has plural neurons containing at least one neuron for generating output accompanied by an analog delay based on the input signal, and has a configuration of a recurrent neural network including a loop of a signal stream, wherein
when the pattern generator fetches a detected signal input from the signal input section, and the detected signal is changed to a signal of a desired pattern, an output different from an output obtained when the detected signal has a pattern other than a desired pattern is generated.

2. The sensor according to claim 1, wherein the pattern generator comprises a neuron for generating output V₁ basically by an equation of
$${ɛ}_{1} \frac{ⅆ {V}_{1}}{ⅆ t} + {V}_{1} = {V}_{0}$$
where V₀ indicates an input, V₁ indicates an output, and ε₁ indicates a delay.

3. The sensor according to claim 1, wherein the pattern generator uses an inner product of a signal generated in the pattern generator and the detected signal.

4. The sensor according to claim 1, wherein the pattern generator uses a coefficient drive.

5. The sensor according to claim 1, wherein the pattern generator generates a cyclical function in the pattern generator.

6. The sensor according to claim 1, wherein the pattern generator generates a non-cyclical function expressed by a polynomial in the pattern generator.

7. A sensor program storage medium storing a sensor program which is executed in an information processing device for executing a program, operates the information processing device as a sensor for detecting whether or not a dynamically input detected signal is a signal of a desired pattern, and operates the information processing device as a sensor comprising:
a signal input section which inputs a detected signal; and
a pattern generator having plural neurons containing at least one neuron for generating output accompanied by an analog delay based on the input signal, and having a configuration of a recurrent neural network including a loop of a signal stream, wherein
when the pattern generator fetches a detected signal input from the signal input section, and the detected signal is changed to a signal of a desired pattern, an output different from an output obtained when the detected signal has a pattern other than a desired pattern is generated.

8. The sensor program storage medium according to claim 7, wherein the pattern generator comprises a neuron for generating output V₁ basically by an equation of
$${ɛ}_{1} \frac{ⅆ {V}_{1}}{ⅆ t} + {V}_{1} = {V}_{0}$$
where V₀ indicates an input, V₁ indicates an output, and ε₁ indicates a delay.

9. The sensor program storage medium according to claim 7, wherein the pattern generator uses an inner product of a signal generated in the pattern generator and the detected signal.

10. The sensor program storage medium according to claim 7, wherein the pattern generator uses a coefficient drive.

11. The sensor program storage medium according to claim 7, wherein the pattern generator generates a cyclical function in the pattern generator.

12. The sensor program storage medium according to claim 7, wherein the pattern generator generates a non-cyclical function expressed by a polynomial in the pattern generator.
